(19) United States
(12) Patent Application Publication
(10) Pub. No.: US 2025/0296254 A1
(43) Pub. Date: Sep. 25, 2025

(54) CHILDRENS WEIGHTED SCISSORS

(71) Applicant: Lynne Marie Ogg, Cedar, MN (US)

(72) Inventor: Lynne Marie Ogg, Cedar, MN (US)

(21) Appl. No.: 19/081,470

(22) Filed: Mar. 17, 2025

Related U.S. Application Data
(60) Provisional application No. 63/567,214, filed on Mar. 19, 2024.

(51) Int. Cl. B26B 13/20; B26B 13/28

(52) U.S. Cl. CPC B26B 13/20; B26B 13/28

(57) ABSTRACT

Adding weights in a prescribed manner to a scissors will provide a tool allowing users (typically students or children) to better develop fine motor skills. This is particularly helpful when helping users deal with neurological issues that may challenge their abilities. The weighted scissor will be heavier than a typical scissors, which can help in skill development. In some embodiments, the weight is focused in the handles thus requiring addition effort to operate.

### BACKGROUND

Children with neurological difficulties often need extra neurological input in order to elicit a response from their muscles and joints, and to provide signals to the receptors within the brain, which elicit increased perception and control of the body to elicit improved motor planning and smoother movements. All children need to improve upper extremity body awareness to attain and refine functional fine motor skills, including but not limited to cutting, writing, drawing, pencil grasp, and clothing fastener manipulation. One way to help children develop motor skills is to use devices that are heavier than normal. For example, weighted eating utensils and pencil weights and weighted pens for writing/drawing/coloring (both within the same 3-6 oz parameters) are available and used to assist with certain conditions by decreasing tremors and providing proprioceptive feedback for increased body awareness and quicker skill attainment, in children with and without neurological difficulties/delays.

Currently, no weighted scissors exist to help children with their motor skills during growth and development. This is not surprising since the type of scissors which would be helpful are unbalanced, with only certain portions carrying additional weight. The typical goal for most scissors is to balance weight in the handles and blades to make scissor operation easier. Other adaptive scissors, currently on the market, offer: (1) spring action for poor hand strength; (2) electric scissors for children who are unable to open/close a scissors; (3) adapted handles for children who have difficulty grasping the concept of opening/closing scissors or poor finger grasp on scissors; or (4) table top and table mounted scissors for children who are unable to use their fingers to manipulate a scissors. None of these devices offer benefits or features which will help with the development of strength and critical motor skills that some children need.

### SUMMARY

Weighting the scissors in a prescribed manner allows for a higher amount of sensory feedback from the muscles and joints of the fingers, wrist, arm, elbow and shoulder in order to: (a) help calm the sensory system, in the case of children with high thresholds of proprioceptive feedback, and (b) provide more feedback from the joints and muscles to help the brain with body awareness and purposeful movement learning. It can also help calm mild tremors in children with tremulous fine motor movements. While various embodiments can exist, one example of a product to address the concerns set for above includes a child size scissors with weighted handles, with metal material handles. The weighted material may be 4-7 oz in weight and may be in both handles of the scissors. The goal is to generally increase the weight of the overall scissors.

The embodiments set disclosed herein provide a weighted scissors designed to provide proprioceptive input to children, for both right and left-handed children, while cutting for multiple benefits. The proprioceptive input provides weight to help calm the nervous system for children seeking heavy input. It also provides biofeedback to the nervous system to assist with body awareness, which assists in decreasing learning time for cutting skills. The weight also provides stabilization for students who experience tremulousness in their upper body. Therefore, weighted scissors has multiple benefits and uses for children in various settings, including but not limited to: outpatient therapy, schools, home, and hospitals.

The adaptive scissors described herein primarily addresses three major areas, lack of strength to open/close a scissors, lack of finger dexterity to grasp a scissors correctly, and lack of overall motor capacity to operate a typical scissors.

In some aspects, the techniques described herein relate to a weighted scissors for providing proprioceptive feedback to a child during cutting or therapy, The weighted scissors generally having a first blade member and a second blade member configured to be rotatably coupled to one another about an axis point located proximate a first end of both the first blade member and the second blade member. The first blade member and the second blade member both have a cutting edge along a side portion of a second end which are positioned in a cooperating relationship when first blade member and the second blade member are rotatably coupled to one another. A first handle member has an enclosed loop at a first end and an attachment structure at another end, with the first handle being formed to have a predetermined overall weight, with the enclosed loop configured to contain a majority of the weight. The attachment structure of the first handle member being attachable to the first blade member so that a hole in the attachment structure is aligned with the axis point. The weighted scissors having a second handle member with an enclosed loop at a first end and an attachment structure at a second end, with the second handle being formed to have a predetermined overall weight. The attachment structure of the second handle member being attachable to the second blade member so that a hole in the attachment structure is aligned with the axis point. When first handle member and the second handle member are coupled to the first blade member and the second blade member respectively, each are able to rotate about the axis point thereby causing the cutting edge of the first blade member and the cutting edge of the second blade member to cooperate with one another and create a cutting action.

In some aspects, the techniques described herein relate to a weighted scissors wherein the first handle member and the second handle member have a length which is longer than a length of the first blade member and the second blade member.

In some aspects, the techniques described herein relate to a weighted scissors wherein a combined weight of the first handle member and the second handle member is greater than 4 oz.

In some aspects, the techniques described herein relate to a weighted scissors wherein the first blade member and the second blade member are substantially identical to one another.

In some aspects, the techniques described herein relate to a weighted scissors wherein the enclosed loop of the first handle member is configured to receive at least one finger of the child during use and the enclosed loop of the second handle member is configured to receive a thumb of the child.

In some aspects, the techniques described herein relate to a weighted scissors wherein the predetermined overall weight of the first handle member and the predetermined overall weight of the second handle member are substantially equal.

In some aspects, the techniques described herein relate to a weighted scissors wherein the predetermined overall weight of the first handle member is substantially less than the predetermined overall weight of the second handle member.

In some aspects, the techniques described herein relate to a weighted scissors wherein the first handle member and the second handle member each include an inner structure and a plastic outer covering.

### BRIEF DESCRIPTION OF THE DRAWINGS

Further features and advantages of the preferred embodiments are described in the description below and shown in the drawings, in which:

FIG. 1 shows a perspective view of one embodiment of the weighted scissors;

FIG. 2 presents an exploded view of the weighted scissors;

FIG. 3 is a front view of the weighted scissors;

FIG. 4 shows a front view of a blade member;

FIG. 5 is a perspective view of the blade member;

FIG. 6 is s perspective view of a first handle member;

FIG. 7 presents a front view of the first handle member;

FIG. 8 shows a side view of the first handle member;

FIG. 9 is a second front view of the first handle member;

FIG. 10 is s perspective view of a second handle member;

FIG. 11 presents a front view of the second handle member;

FIG. 12 shows a side view of the second handle member; and

FIG. 13 is a second front view of the second handle member.

### DESCRIPTION

Various embodiments of the weighted scissors are set forth below to provide a general understanding of how this product will provide benefits to users. While certain details are discussed, it will be recognized that variations may exist, and this description is not intended to be limiting in any way. Also, the discussion below outlines the benefits for students and/or children, but it will be understood that these same benefits can be provided to anyone who is dealing with neurological or motor skill issues, and thus it is not intended that other individuals would be excluded.

Weighing the scissors helps with two major areas. First, it helps to provide extra proprioceptive feedback to the joints of the arm/shoulder, which helps to calm the nervous system of students who have an under-responsiveness to this system and seek more during fine motor tasks, while also providing extra input into the muscles and joints of the hand, wrist, arm and shoulder when children are learning to cut, which helps with overall body awareness of the upper body when a student is learning to cut. This can also benefit other areas of fine motor skill attainment as body awareness is needed in learning to grasp a writing utensil, write and draw, complete clothing fasteners and all other small motor tasks. Second, this can assist in decreasing uncontrolled movement in children with tremulousness in their hands and upper extremities during movement. Decreasing tremulousness can assist with increased motor control during cutting tasks.

The weighting of the scissors in a prescribed manner provides multiple benefits. First, this is helpful in slowing tremulous movement in the hands of children with mild upper body tremors while cutting with scissors. Weighted items can assist in decreasing the severity of mild tremors in children, therefore providing increased control of the scissors while cutting. Second, weighting the scissors can provide proprioceptive feedback for children to increase body awareness when learning to cut with a scissors. This is especially helpful for children with motoric and neurological delays while learning to cut with a scissors. The increased bio-feedback assists with quicker attainment of cutting skills in children with or without motor or neurological difficulties/delays and increased postural stability of the shoulder and elbow during cutting. Third, for children who seek increased proprioceptive input, the weight is beneficial in assisting to meet this sensory seeking need. In summary, it is beneficial for decreasing mild tremors, increased cutting skill attainment, bio-feedback and meeting proprioceptive seeking needs for children. Weighted scissors can be used in multiple environments: schools, rehabilitation facilities, and personal home use.

Currently, no weighted scissors exist, but weighted eating utensils and pencil weights and weighted pens for writing/drawing/coloring (both within the same 3-7 oz parameters) are available and used to assist with decreasing tremors or providing proprioceptive feedback for increased body awareness and quicker skill attainment, in children with and without neurological difficulties/delays. Other adaptive scissors, currently on the market, include: (1) spring action scissors for poor hand strength; (2) electric scissors for children who are unable to open/close a scissors; (3) adapted handles for children who have difficulty grasping the concept of opening/closing scissors or poor finger grasp on scissors; and (4)_table top and table mounted scissors for children who are unable to use their fingers to manipulate a scissors. The weighted scissors would differ from currently available adaptive scissors in providing proprioceptive feedback to their neurological systems for increased attainment of cutting skills and to decrease tremulousness in children who present with mild upper body tremors. This extra proprioceptive feedback will also strengthen finger and hand muscles in children who are needing to increase their hand and finger strength for fine motor skills.

A typical child scissor weighs roughly 0.95 oz (27 grams) to 1.20 oz (34 grams), which are typically designed to be light weight and thus easy for a typical child user to operate. By adding 3-6 oz, the target weight for the weighted scissors would be approximately 4 oz (113.398 grams) to 7 oz (198.447 grams). As mentioned above, the weighted scissors would continue to be “child-sized” thus balancing the size with the desired therapeutic value of added weight. Alternatively, metal handles can also provide increased proprioceptive feedback to the fingers and hands in the temperature and texture, which increases tactile input as well as proprioceptive input with the weight. It can be formed in a similar configuration and controlled weight. As mentioned above, it may be beneficial to spread the weight across the entire scissors, or it may be beneficial to distribute the weight unevenly in the handles or the blade. Placing the weight in the handles will obviously put additional weight immediately in the patient's/student's hands, thereby increasing the strength required to simply hold, position, and manipulate the scissors. In certain circumstances this will be very beneficial, depending on the particular nature of the patient's/student's condition. If the weight is evenly or unevenly balanced, this will change the force needed to move the blades, thus creating a therapy device that will be beneficial for other multiple patient's/student's.

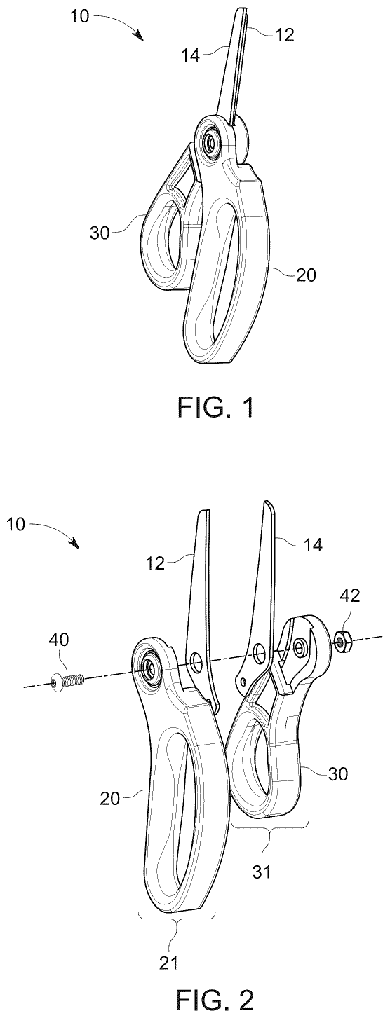

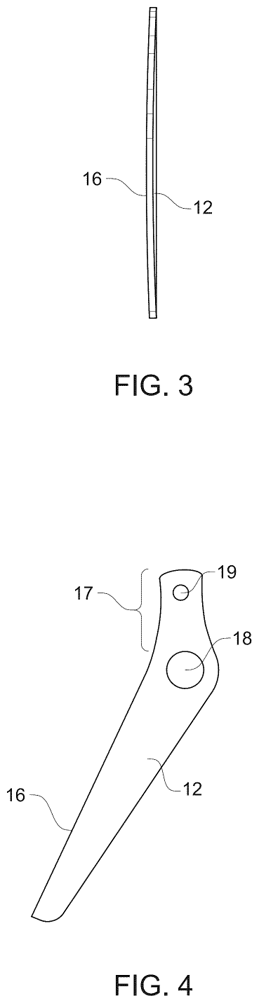

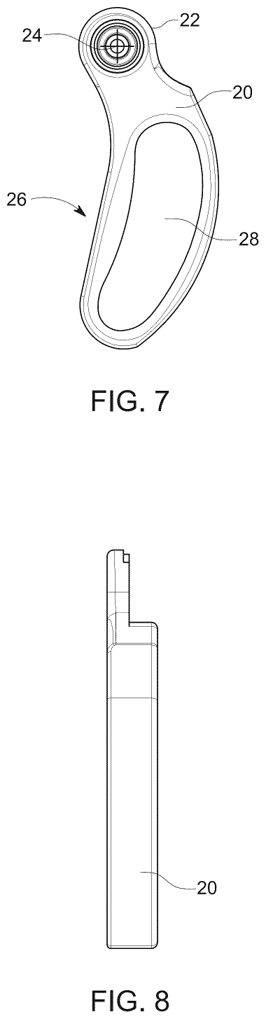

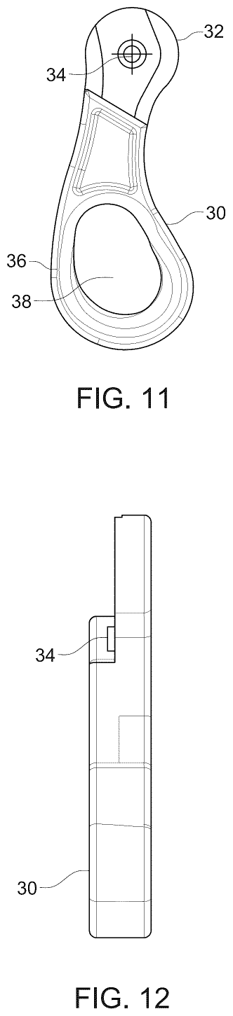

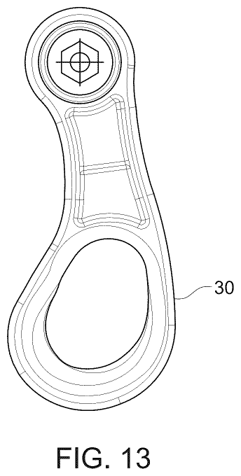

The scissors illustrated in FIGS. 1-13 include additional weights in the handles only, as this is the most beneficial method in distributing the weight directly into the hands of the child/student. The handles are also fully metal to allow additional tactile feedback to the hands while cutting.

Progressive weights are not necessary as the feedback the current weight provides assists in body awareness skills that will allow for eventual transition to a non-adaptive scissors as a child gains increased strength, muscle control, and motor memory skills for cutting tasks. If a child is using the weighted scissors for purely sensory integration purposes, however continued use is recommended at the current weight to continue to assist the child in calming the nervous system.

Manufacturing processes are also more efficient and cost effective if weight is provided in the handles. As mentioned, it is anticipated that one embodiment will include handles formed of metal, and can have a volume and weight which can be easily varied in many ways. Comparatively, the dimension and size of the blades does not easily allow for significant variations in weight.

Turn now to the figures, and specifically FIGS. 1 and 2, one embodiment of a weighed scissors 10 is illustrated in perspective and exploded views respectively. As shown, weighed scissors 10 includes a first blade 12 and a second blade 14 which are coupled to a first handle member 20 and a second handle member 30 respectively. First handle member 20 and first blade 12 are coupled to one another. In this embodiment, it is anticipated that they will be nested with one another using a slot (not shown) that allows first blade 12 to be inserted into a portion of first handle 20. Similarly, second handle 30 and second blade 14 are coupled to one another in a similar nested manner.

The first blade 12 and first handle 20 make up a first half 21 of the scissors 10, while the second blade 14 and second handle 30 make up a second half 30 of the scissors 10, which are both coupled to one another by an attachment bolt 40. More specifically, a bolt 40 and related nut 42 are used to couple the first half and second half to one another.

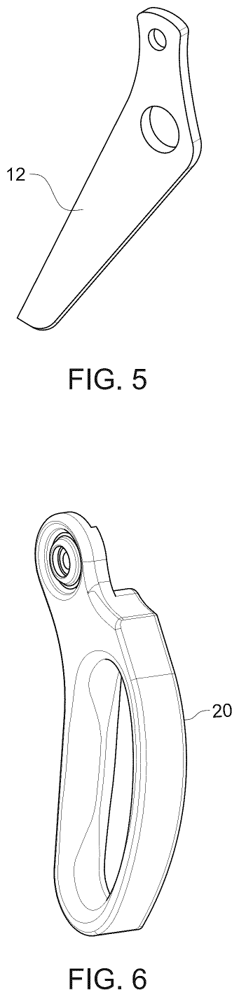

Turning now to FIGS. 4 and 5, first blade 12 is shown in more detail. That said, it will be recognized and understood that first blade 12 and second blade 14 are identical to one another, and are simply utilized in an opposing manner. Clearly, this optimizes manufacturing efficiency, and helps reduce overall cost for weighed scissors 10. For purposes of discussion, first blade 12 is described in conjunction with FIGS. 4 and 5. More specifically, first blade 12 has a cutting edge 16, which is positioned along an elongated portion of first blade 12. An attachment end or attachment tab 17 is utilized to accommodate attachment to handles 20, and 30, as further discussed below. In a related manner, a coupling hole 19 exists within the connection end 17. Lastly, an axis hole 18 is positioned near attachment tab 17, which is utilized to accommodate coupling of first half 21 and second half 31.

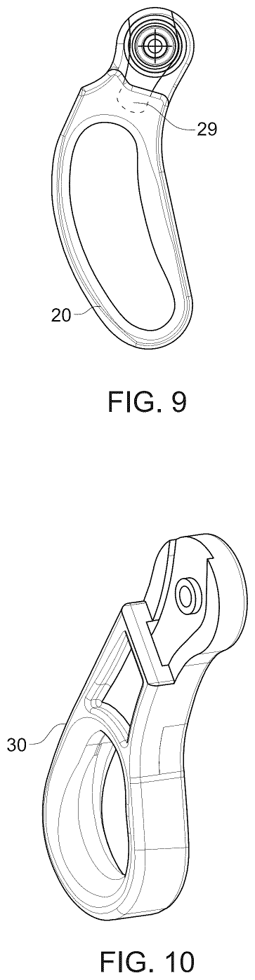

Referring now to FIGS. 6-9, first handle 20 is illustrated in additional detail. As shown, first handle 20 will include a pivot end 22, which supports and houses a pivot hole 24. As will be appreciated, first handle member 20 is coupled with first blade 12, and will be aligned so that pivot hole 24 of first handle 20 and axis hole 18 of first blade member 12 are aligned with one another and configure to receive attachment pin 40. At an opposite end of first handle 20 a grip portion 26 exists, having a handle opening 28 configure to receive a portion of the users hand. Turning specifically to FIG. 9, a receiving slot 29 is illustrated in dash line format, which is specifically designed to receive attachment tab 17 of first blade 12. As will be anticipated, handle 20 could easily be formed around first blade 12 during the manufacturing process or could be attached in different ways. As one example, it is possible that an attachment pin (not shown) could be utilized to connect first handle 20 and first blade 12.

Turning now to FIGS. 10-13, second handle 30 is illustrated in more detail. It will be appreciated that many of the features of second handle 30 are somewhat similar to those in first handle 20, however in this embodiment the overall configuration is slightly different. More specifically, second handle 30 includes an attachment portion 32 and an attachment opening 34, which again is configured to receive attachment pin 40. Second handle 30 also includes a handle portion 36 with an opening 38 that is also configured to receive another portion of the users hands. In this particular embodiment, it is anticipated that opening 38 would accommodate a users thumb, while opening 28 (in first handle member 20) would accommodate a users fingers. Naturally, variations are possible. As best shown in FIG. 12, second handle 30 also includes an attachment slot 39 which again is configured to receive a portion of blade 14 and provide a nested coupling.

Although not explicitly illustrated in the figures, it is anticipated that first handle 20 and second handle 30 are again fabricated from a solid metal material, whether this be molded, stamped or otherwise fabricated. More significantly, first handle 20 and second handle 30 are weighed in a predetermined manner so that they are significantly heavier than first blade 12 and second blade 14, and also make weighed scissors 10 significantly heavier than existing scissors. Again, this helps to provide therapeutic benefits to users are generally discussed above.

Another possible variation comprises the formation of first half 21 and second half 31 as a single piece. These could be machined or molded in different ways, depending upon the specifications and tolerances involved. Additionally, it is contemplated that weighting could be achieved by using different materials and having weights embedded into particular locations of the handles. This would allow for precise placement of weights ad the ability to obtain a very specific weight balance for the users.

Various embodiments of the invention have been described above for purposes of illustrating the details thereof and to enable one of ordinary skill in the art to make and use the invention. The details and features of the disclosed embodiment[s] are not intended to be limiting, as many variations and modifications will be readily apparent to those of skill in the art. Accordingly, the scope of the present disclosure is intended to be interpreted broadly and to include all variations and modifications coming within the scope and spirit of the appended claims and their legal equivalents.

1. A weighted scissors for providing proprioceptive feedback to a child during physical therapy, the weighted scissors comprising:
a first blade member and a second blade member configured to be rotatably coupled to one another at an axis point located proximate a first end of both the first blade member and the second blade member, and wherein the first blade member and the second blade member both have a cutting edge along a side portion of a second end of both the first blade member and the second blade member and which are positioned in a cooperating relationship when first blade member and the second blade member are rotatably coupled to one another;
a first handle member having an enclosed loop at a first end and an attachment structure at a second end, the first handle being formed to have a predetermined overall weight, with the enclosed loop configured to contain a majority of the weight, the attachment structure of the first handle member being attachable to the first blade member so that a hole in the attachment structure is aligned with the axis point; and
a second handle member having an enclosed loop at a first end and an attachment structure at a second end, the second handle being formed to have a predetermined overall weight, the attachment structure of the second handle member being attachable to the second blade member so that a hole in the attachment structure is aligned with the axis point;
wherein the first handle member and the second handle member are coupled to the first blade member and the second blade member so that they are each able to rotate about the axis point thereby causing the cutting edge of the first blade member and the cutting edge of the second blade member to cooperate with one another and create a cutting action.

2. The weighted scissors of claim 1 wherein the first handle member and the second handle member have a length which is longer than a length of the first blade member and the second blade member.

3. The weighted scissors of claim 1 wherein a combined weight of the first handle member and the second handle member is greater than 4 oz.

4. The weighted scissors of claim 1 wherein the first blade member and the second blade member are substantially identical to one another.

5. The weighted scissors of claim 4 wherein the enclosed loop of the first handle member is configured to receive at least one finger of the child during use and the enclosed loop of the second handle member is configured to receive a thumb of the child.

6. The weighted scissors of claim 5 wherein the predetermined overall weight of the first handle member and the predetermined overall weight of the second handle member are substantially equal.

7. The weighted scissors of claim 5 wherein the predetermined overall weight of the first handle member is substantially less than the predetermined overall weight of the second handle member.

8. The weighted scissors of claim 4 wherein the first handle member and the second handle member each comprise an inner structure and a plastic outer covering.

9. A weighted scissors for providing proprioceptive feedback to a child during physical therapy, the weighted scissors comprising:
a first blade member and a second blade member configured to be rotatably coupled to one another at an axis point located proximate a first end of both the first blade member and the second blade member, and wherein the first blade member and the second blade member both have a cutting edge along a side portion of a second end of both the first blade member and the second blade member and which are positioned in a cooperating relationship when first blade member and the second blade member are rotatably coupled to one another;
a first handle member having an enclosed loop at a first end and an attachment structure at a second end, the first handle being formed to have a predetermined overall weight, with the enclosed loop configured to contain a majority of the weight, the attachment structure of the first handle member being attachable to the first blade member so that a hole in the attachment structure is aligned with the axis point; and
a second handle member having an enclosed loop at a first end and an attachment structure at a second end, the second handle being formed to have a predetermined overall weight, the attachment structure of the second handle member being attachable to the second blade member so that a hole in the attachment structure is aligned with the axis point; wherein the first handle member and the second handle member are coupled to the first blade member and the second blade member so that they are each able to rotate about the axis point thereby causing the cutting edge of the first blade member and the cutting edge of the second blade member to cooperate with one another and create a cutting action.

10. The weighted scissors of claim 9 wherein the first handle member and the second handle member have a length which is longer than a length of the first blade member and the second blade member.

11. The weighted scissors of claim 9 wherein a combined weight of the first handle member and the second handle member is greater than 4 oz.

12. The weighted scissors of claim 9 wherein the first blade member and the second blade member are substantially identical to one another.

13. The weighted scissors of claim 10 wherein the enclosed loop of the first handle member is configured to receive at least one finger of the child during use and the enclosed loop of the second handle member is configured to receive a thumb of the child.

14. The weighted scissors of claim 13 wherein the predetermined overall weight of the first handle member and the predetermined overall weight of the second handle member are substantially equal.

15. The weighted scissors of claim 13 wherein the predetermined overall weight of the first handle member is substantially less than the predetermined overall weight of the second handle member.

16. The weighted scissors of claim 9 wherein the first handle member and the second handle member each comprise an inner structure and a plastic outer covering.
